(19) United States
(12) Patent Application Publication
(10) Pub. No.: US 2022/0147223 A1
(43) Pub. Date: May 12, 2022

(54) SYSTEM AND METHOD FOR CORRECTING TYPING ERRORS

(71) Applicant: Saad Al Mohizea, Riyadh (SA)

(72) Inventor: Saad Al Mohizea, Riyadh (SA)

(21) Appl. No.: 17/366,206

(22) Filed: Jul. 2, 2021

Related U.S. Application Data
(60) Provisional application No. 63/110,994, filed on Nov. 7, 2020.

(51) Int. Cl. G06F 3/0481; G06F 3/0486; G06F 3/0488

(52) U.S. Cl. CPC G06F 3/04812; G06F 3/04883; G06F 3/0486

(57) ABSTRACT

A system and method for facilitating text editing on a touch sensitive display device is disclosed. The system detects a touch action on the touch sensitive display. The system determines if the touch action exceeds beyond a predefined threshold time, and determine if the touch action exceeds beyond a predefined threshold time. In response to the touch action and the threshold time, the system executes at least one function on an area of occurrence of the touch action. Further, a virtual trackpad is activated that allows movement of a pointer throughout the display relative to a touch input provided by movement of user's finger on the display to execute one or more functions.

### BACKGROUND OF THE INVENTION

The present disclosure relates to processing of data, and specifically relates to a system and method for facilitating editing of text on a touch-sensitive display.

Typing on touching screens have been revolutionized by utilizing virtual keyboards that can be accessed through a touch screen or touch surfaces such as trackpads. However, correcting typos can be especially difficult on smaller screens and when implementing a group of gestures and actions such as placing a cursor, highlighting a letter, highlighting a word or moving back and forth between letters or words. All of the above can confuse users and lead to errors when attempting to correct errors.

A known method for placing a cursor in smart phones is one that uses a virtual trackpad activated by holding the space bar for a while before the trackpad is activated. This is available in both IOS and android platforms. Although this method offers a way for moving the cursor, other steps or actions are needed to finish the task of correcting a misspelling, which forces the user to gaze back and forth between the keyboard and the cursor and invariably requires the user to remove his finger off the screen and place it again one or more times before finishing the task. This can be difficult especially in smaller screens and such task may need to be done over and over for multiple words, and can lead to fatigue.

U.S. Pat. No. 8,358,281 describes a magnification loupe that is displayed when the user is touching the screen, which enables the user to better view small interphase elements with touch-based gesturing and move the cursor around. It would be desirable to speed and improve the precision by which a user can type on touch sensitive surfaces.

The present disclosure is directed to alleviate one or more limitations stated above or any other limitations associated with the conventional systems.

Thus, it is one object of the present subject matter to provide a system and a method for facilitating editing of text, when the user is using a touch screen and touching the letter or word to be edited.

It is also an object of the present subject matter to provide a system and a method that simplifies editing text with a virtual trackpad.

### SUMMARY

This summary is provided to introduce aspects related to a system and a method for facilitating editing of text and the aspects are further described below in the detailed description. This summary is not intended to identify essential features of the claimed subject matter nor is it intended for use in determining or limiting the scope of the claimed subject matter.

In one non-limiting embodiment of the present disclosure, a system for facilitating editing of text on a touch sensitive display is disclosed. The system comprises a processor, a touch sensitive display in communication with the processor and a memory. The memory is configured to store a set of program modules executed by the processor. The set of modules includes an input module, a processing module, and an output module. The input module is configured to detect a touch action on the touch sensitive display. The processing module is configured to determine if the touch action exceeds beyond a predefined threshold time, and determine an area of the touch action relative to a character. The output module is configured to, in response to the touch action and the threshold time, execute at least one function on an area of occurrence of the touch action. The area of occurrence includes at least one character, at least a portion of a character, or an empty space.

In one non-limiting embodiment of the present disclosure, a method to facilitate text editing is disclosed. The method incorporated in the system comprising a processor, a touch-sensitive display, and a memory storing a set of program modules executable by the processor. At one step, the input module, executed at the processor, is configured to detect a touch action on the touch sensitive display. At another step, the processing module, executed by the processor, is configured to determine if the touch action exceeds beyond a predefined threshold time, and determine an area of the touch action relative to a character. The area of occurrence includes at least one character, at least a portion of a character, or an empty space.

In one embodiment, the function includes placement of cursor, displaying a cursor, editing character, automatic highlight of character, magnifying character, selecting character and deleting character. In one embodiment, each function has a respective threshold time. In one embodiment, the area relative to the character includes a first area and a second area. The first area defines an area occupied by the character and the second area defines an area around the character.

In response to touch action and threshold time at the first area, at least one function is executed on the area of occurrence of the touch action. In response to touch action and threshold time at the second area, at least one function is executed on the area of occurrence of the touch action. The input module is configured to enable the user to drag one or more characters from one area of the display and drop at another area of the display for execution of at least one function utilizing the virtual trackpad, and the area includes a virtual keyboard and an output window.

In one embodiment, the automatic deletion of character involves: placing cursor at an area requiring deletion function beyond a predefined threshold of time; detecting the placement of cursor at the area requiring selection and deletion beyond the predefined threshold of time, and deleting the selected area on removal of touch contact by a user from the display. In one embodiment, the automatic highlight of character is implemented by placement of the cursor at an area of the character requiring highlight for a predefined threshold time. In one embodiment, the magnifying function is implemented by moving the cursor over the character for selection, and magnifying the character on the display if the touch action exceeds beyond predefined threshold time.

### BRIEF DESCRIPTION OF ACCOMPANYING DRAWINGS

FIG. 1 is a block diagram of an exemplary computer system to facilitate editing of text, according to an embodiment of the present invention.

FIG. 2 is a flowchart of a method to facilitate editing of text, according to an embodiment of the present invention.

FIG. 3 shows a first area and a second area around the character, according to an embodiment of the present invention.

FIG. 4 is a flowchart of method for deletion of character, according to an embodiment of the present invention.

FIG. 5A exemplarily illustrates a display including an output window and virtual keyboard, according to an embodiment of the present invention.

FIG. 5B exemplarily illustrates selection of a character from a virtual keyboard, according to an embodiment of the present invention.

FIG. 5C exemplarily illustrates activation of virtual trackpad, according to an embodiment of the present invention.

FIG. 5D exemplarily illustrates movement of cursor, according to an embodiment of the present invention.

FIG. 5E exemplarily illustrates editing text using the virtual trackpad, according to an embodiment of the present invention.

FIG. 6 is flowchart of a method for highlighting a character, according to an embodiment of the present invention.

FIG. 7A exemplarily illustrates a user navigating a cursor between characters, according to an embodiment of the present invention.

FIG. 7B exemplarily illustrates a user navigating a cursor over a character, according to the embodiment of FIG. 7A.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary devices and methods are now described. The disclosed embodiments are merely exemplary of the disclosure, which may be embodied in various forms.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

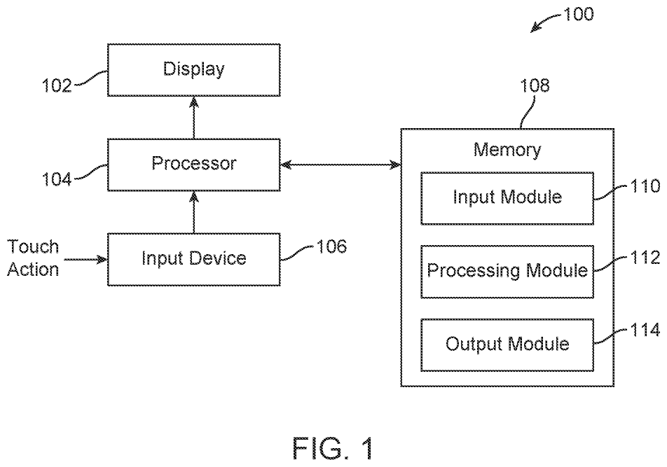

FIG. 1 is a block diagram of an exemplary computer system 100 for facilitating text editing is disclosed, according to an embodiment of the present invention. The system 100 corresponds to a personal computer system, such as a desktops, laptops, tablets or handheld computer.

The computer system 100 can also correspond to a computing device, such as a cell phone, PDA, dedicated media player, consumer electronic device, and the like. The exemplary computer system 100 shown in FIG. 1 can include a processor 104 configured to execute instructions and to carry out operations associated with the computer system 100. For example, using instructions retrieved for example from memory 108, the processor 104 can control the reception and manipulation of input and output data between components of the computing system 100. The processor 104 can be implemented on a single-chip, multiple chips or multiple electrical components. For example, various architectures can be used for the processor 104, including dedicated or embedded processor, single purpose processor, controller, ASIC, and so forth.

In most cases, the processor 104 together with an operating system operates to execute computer code and produce and use data. Operating systems are generally well known and will not be described in greater detail. By way of example, the operating system can correspond to OS/2, DOS, Unix, Linux, Palm OS, and the like. The operating system can also be a special purpose operating system, such as ones that can be used for limited purpose appliance-type computing devices. The operating system, other computer code and data can reside within a memory 108 that can be operatively coupled to the processor 104. Memory 108 generally provides a place to store computer code and data that can be used by the computer system 100. By way of example, the memory 108 can include Read-Only Memory (ROM), Random-Access Memory (RAM), hard disk drive and/or the like. The information could also reside on a removable storage medium and loaded or installed onto the computer system 100 when needed. Removable storage mediums include, for example, CD-ROM, PC-CARD, memory card, floppy disk, magnetic tape, and a network component.

The computer system 100 can also include a display device 102 that can be operatively coupled to the processor 104. As discussed above, the input device 106 can be a touch screen that is positioned over or in front of the display 102, integrated with the display device 102, or can be a separate component, such as a touch pad. Again, although FIG. 1 illustrates the input device 106 and the display 102 as two separate boxes for illustration purposes, the two boxes can be realized on one device.

The memory 108 configured to store a set of program modules executed by the processor. The set of modules includes an input module 110, a processing module 112, and an output module 114. The input module 110 is configured to detect a touch action on the touch sensitive display. The processing module 112 is configured to determine if the touch action exceeds beyond a predefined threshold time, and determine an area of the touch action relative to a character. The output module 114 is configured to, in response to the touch action and the threshold time, execute at least one function on an area of occurrence of the touch action. The area of occurrence includes at least one character, at least a portion of a character, or a space.

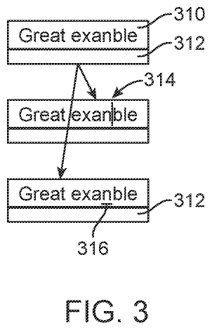

The input module can be configured to enable the user to drag one or more characters from one area of the display and drop at another area of the display for execution of at least one function utilizing the virtual trackpad. The function may include one or more of the following, placement of cursor, displaying a cursor, or editing character or space, such as automatic highlighting, magnifying, selecting, deleting or substituting characters. In one embodiment, the area relative to the character includes a first area and a second area. The first area defines an area occupied by the character and the second area defines an area around the character. This is shown in FIG. 3 and will be discussed in greater detail later.

In one embodiment, in response to touch action and threshold time at the first area, at least one function is executed on the area of occurrence of the touch action. In response to touch action and threshold time at another second area, at least one function is executed on the area of occurrence of the touch action. The input module 110 is configured to enable the user to drag one or more characters from one area of the display 102 and drop at another area of the display 102 for execution of at least one function utilizing the virtual trackpad, and the area includes a virtual keyboard and an output window.

In one embodiment, the automatic highlighting of character involves: placing cursor at an area requiring highlighting beyond a predefined threshold of time; detecting the placement of cursor at the area beyond the predefined threshold of time, and automatically highlighting the selected area on removal of touch contact by a user from the display without moving to another area 102. Preferably, a magnifying lens is used to better see the characters. Such lens can be activated by methods such as forcible touch technology. In a variation of the above, another function is executed other than automatic highlighting, such as deletion of character.

In yet another variation, the automatic highlight of character is implemented only by placement of the cursor at a predefined area around the character rather than onto the character itself, such as area 312 seen in FIG.3.

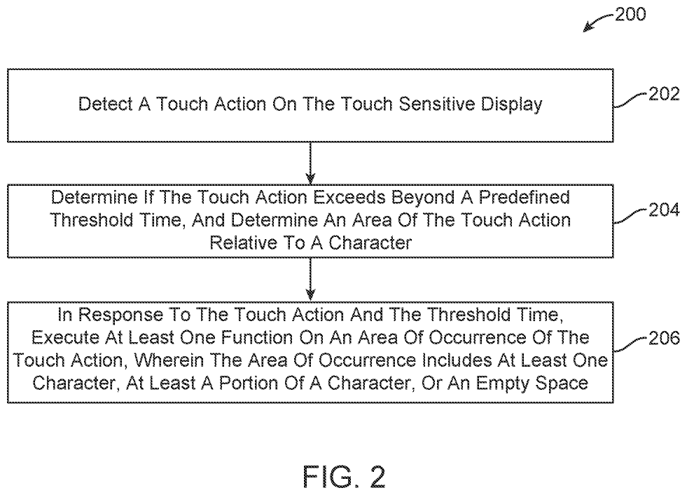

Referring to FIG. 2, a method 200 to facilitate text editing is disclosed, according to an embodiment of the present invention. The method 200 incorporated in the system comprising a processor, a touch-sensitive display, and a memory storing a set of program modules executable by the processor. At step 202, the input module, executed at the processor, is configured to detect a touch action on the touch sensitive display. At step 204, the processing module, executed by the processor, is configured to determine if the touch action exceeds beyond a predefined threshold time, and determine an area of the touch action relative to a character. At step 206, the output module, in response to the touch action and the threshold time, is configured to execute at least one function on an area of occurrence of the touch action. The area of occurrence includes at least one character, at least a portion of a character, or an empty space. The first area defines an area occupied by the character and the second area defines an area around the character.

In response to touch action and threshold time at the first area, at least one function is executed relative to the area of contact. In response to touch action and threshold time at the second area, another function is executed on the area relative to the area of contact. Example for first and second areas are shown in FIG. 3 with areas 310 and 312 having different functions.

Referring to FIG. 3, the input module is configured to determine the touch action on the display relative to the area occurrence of the touch action. In one embodiment, the area of occurrence includes at least one character or space. Based on the area where touch action takes place, one or more functions are executed. The areas include a first area 310 and a second area 312. The first area 310 defines an area occupied by the character and the second area 312 defines an area around the character. The second area 312 could be configured to be elsewhere such as below the character or space. The functions include, but not limited to, placing a cursor, editing text and highlighting. Editing text include, but not limited to, adding, deleting, moving or substituting character or space. The user can execute one or more function by performing touch action on the respective area (310, 312). As shown, performing touch action on the first area 310, the cursor is displayed vertically 314 between characters or words. The user can do functions like placing a cursor.

If the user moves his finger beyond area 310 to area 312 the interphase changes the cursor to a horizontal cursor below 316, which can be used in actions, including but not limited to, highlighting a single character or space. The areas 310, 312 are boarded for explanatory purpose to the reader. As explained above, the touch action at the first area 310 and the second area 312 are visually differentiated and indicated by changing the orientation of cursor. In a variation, the cursor may change the color or shape signaling a change in function between the first area 310 and the second area 312. It is understood that picking the first or second area simply by touching is difficult in smaller screens, and therefore such embodiment works best with a virtual trackpad as will be described later in another embodiment with the cursor being maneuvered from the virtual trackpad away from the text to be edited and fully visible.

In a variation, the system is configured to initiate a countdown for highlighting only if the user navigates to the second area 312 of that character to be edited or highlighted. The countdown is initiated to determine satisfaction of predefined time. The final function is canceled if the user is to move the cursor to another area without letting his finger off the screen first.

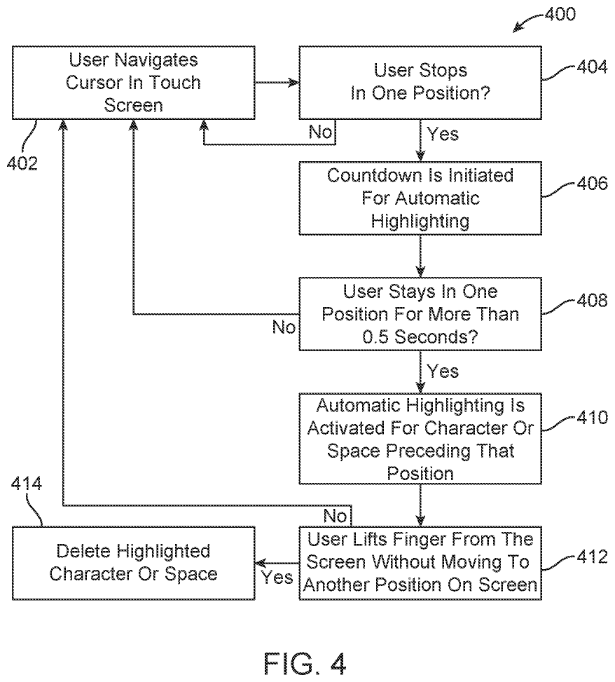

FIG. 4 is a flowchart of method 400 for deletion of character, according to an embodiment of the present invention. At step 402, the user navigates the cursor to a character or space need to be deleted. At step 404, the user places the cursor just proceeding the letter to be deleted.

At step 406, the countdown is initiated for automatic highlighting. If the user places the cursor at the same position for more than a predefined time, At step 410, the character or space preceding, the cursor is highlighted. At step 412, the user removes his finger off the screen without moving the finger to another position on the screen. At step 414, the system understands the placement of the cursor for the predefined time and removal of finger from the display as a request for deletion and deletes the highlighted character. If the user, does not wait for predefined time after placement of cursor, or changes the location of the cursor after highlighting the character without removal of finger first, the delete function will not be activated by the system and automatic highlighting is canceled for that character, and the user is back to step 402.

The system is configured to highlight at least one character or word at the position preceding the cursor if user stays at the same spot for more than a predefined threshold of time. After highlighting is initiated and if the user changes her mind about deletion or if the wrong letter has been highlighted, the user can always move the finger on the display in any direction without lifting her finger, which disables highlighting and takes the user back to the previous stage.

In one embodiment, the system is configured to edit text by dragging and dropping characters from the virtual keyboard to anywhere in the display. The drag and drop function allow the user to drag the character to be substituted and drop at a priming position of the character need to be replaced.

The priming position can be preconfigured to be onto the destination character itself for a substitution or around the destination character for other functions. For example the priming position can be the first area 310 enclosing the character, the second area 312 of that character or at a position proceeding that character. To drag a character, the user needs to perform touch action on the particular character for a predefined time. Once the character become draggable, the user can move the character without lifting his finger from the screen. The user can drop the character at any place of the display depending on the function need to be executed. If the user changes his mind regarding the edit, the user can simply discontinue the drag function and drop the character at the same position where it was dragged from or anywhere outside the output window.

In yet another embodiment, the system allows the user to drag characters from a virtual keyboard to the output window of the display. The user starts by touching a character in the virtual keyboard for more than a predefined threshold of time, at which the character becomes draggable. The user then can drag the letter anywhere in the screen and more specifically to the output window, and depending on where the user drops the character, the function is completed. The system can be configured to allow the user to drag a character and drop onto another character for substitution. Additionally, if the user drops a character in the space between characters or into a position that has no character, the system executes an addition of a character.

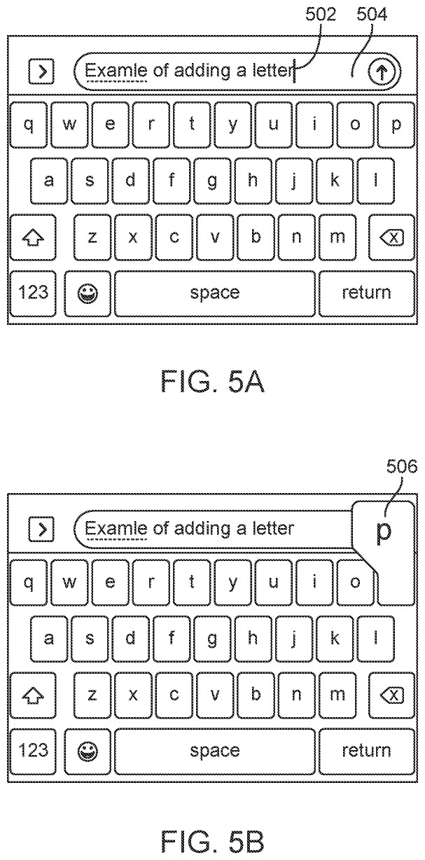

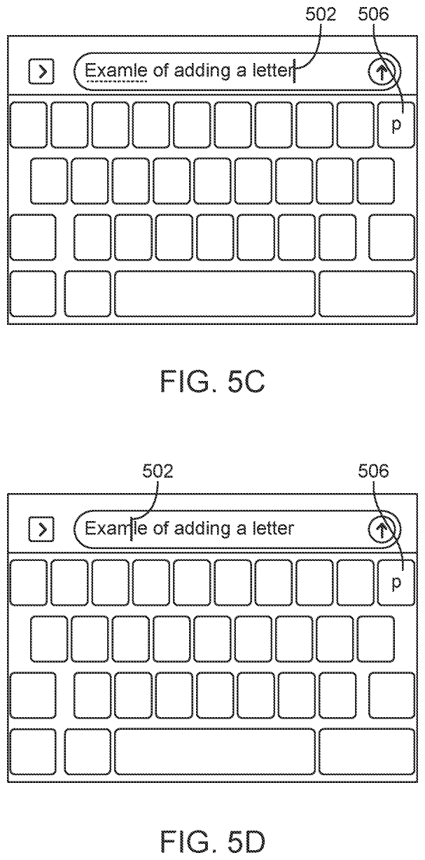

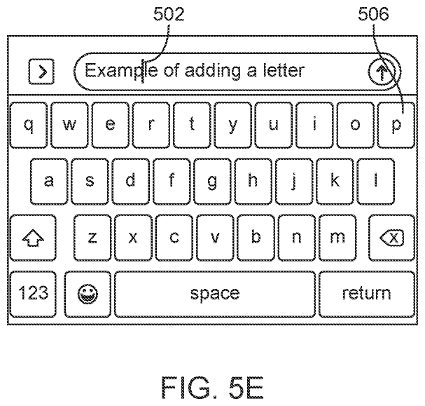

With the use of a virtual trackpad, the draggable character can be navigated without having to touch the words in the output window or the text to be edited, or leave the area of the virtual trackpad. Moreover, the cursor may or may not be replaced by the draggable character in view and function remains the same. The virtual trackpad is activated whenever any point in the virtual keyboard is touched for more than a predefined threshold time of around 0.5 seconds. It is necessary for the user not to move from that point until the threshold time elapsed to activate the virtual trackpad. This will enable the user to navigate the character around from the point of activation without having to remove her finger off or leave the area of the virtual trackpad. A part of or all of the screen can be used as a virtual trackpad until the user removes the finger from the screen. In a variation, the activation of the virtual keyboard can be signaled by dimming or disappearance of the keys on the keyboard as shown in the FIGS. 5C and 5D.

In one embodiment, once the trackpad is activated the user can start moving the cursor. Depending on what particular character she touched first before activating the virtual trackpad, a particular input is actionable and said character can be displayed preferably at the last recorded position of the cursor and is draggable across words and characters in the output window. This continues until the user drops it at the desired location and removing her finger from the screen. This is essentially adding a character for editing text. In doing so the whole process can be done intuitively and fast. Although displaying the character at the last recorded position of the cursor when the virtual keyboard is activated helps the user understand how the system works, displaying is not a must and the cursor can be displayed instead but when dropped it will still drop the character in question.

Referring to FIG. 5A to 5E, a virtual trackpad is utilized to execute one or more edit functions is described in detail. The user starts by touching the letter “p” 506 for more than 0.5 seconds without moving to activate the virtual keyboard as shown in FIG. 5C. At this stage, the user navigates the cursor 502 to edit text and at the same time keeping the finger on the screen. In effect the user is dragging the letter P 506 and can add this character to the text in the output window 504. As shown in FIG. 5D, the user moves the cursor 502 to a position between the letters M and L. At this stage, the user removes her finger effectively dropping the letter P 506 and completing the function of adding a character as shown in FIG. 5E, with the virtual keyboard deactivated. As explained above and after the virtual keyboard is activated instead of displaying a cursor as shown in the figures, the draggable character can be displayed instead.

The system can be configured to execute other edit functions, using the virtual trackpad. For example, the system is configured to substitute one character with another if the user drops the draggable character from the virtual keyboard to the output window and drops onto another character. In such system the positions at the output window are either positions occupied by characters or positions not occupied by characters, including spaces between characters. In the former positions a substitution is performed, whereas in the latter an addition is performed. To enable substitution, the user has to overlap the draggable character onto the character to be replaced in the output window before removing her finger. This can be simplified by a change in the color or shape of either character to signal a transition in command.

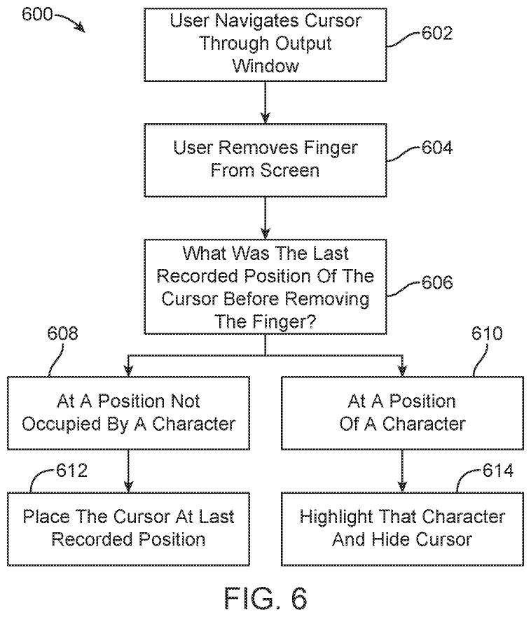

Alternatively, while using the virtual trackpad and to execute different functions depends on where the user drops a cursor or character onto a first or second area as explained previously in FIG. 3. The first area defines an area occupied by the character and the second area defines an area around the character. FIG. 6 is flowchart of a method 600 for highlighting a character, using the virtual trackpad, according to an embodiment of the present invention. At step 602, the user navigates through an output window using the virtual trackpad was activated. At step 604, the user removes his finger from the touch sensitive display or screen. At step 606, the system determines the last recorded position. The last recorded position could be a position occupied by a character, or a space in between characters. If the system determines the last recorded position of cursor as a position not occupied by a character 608 then, the system places the cursor at the last recorded position 612. If the system determines that the last recorded position of cursor was at a position of a character 610. The character is highlighted and cursor is hidden 614.

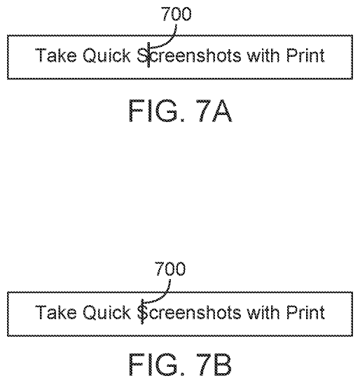

Referring to FIG. 7A, is an example showing a user actively navigating a cursor with a virtual trackpad. This is an example of the first interphase in effect, so when the cursor 700 is in between the characters and the user is letting go of the screen it drops the cursor onto that space, whereas in the second example in FIG. 7B, the cursor 700 is placed and is hovering over the character itself. If the user removes his finger, the character of letter S will be highlighted (not shown in figure).

In a variation and Similar to the above, the same function can be accomplished without using a virtual trackpad, and by dragging characters by configuring the system to do so. In small screens this can be simplified by using a magnifying lens.

In a variation, a change in color or shape of the cursor can be used to signal a change in interphase. So once the user is over a character's designated area, a different signal is given to alert the user that he is at a position that highlights that character rather than placing a cursor. Moreover, one or more functions can be activated based on the level of pressure applied on the touch screen surface by the user. One example being forcible touch actions.

It also understood that pen like devices such styluses commonly used on touch screens can be used as a variation of some of the embodiments in this disclosure. Although the magnification lens has been described in some embodiments, this is not necessary to complete the embodiments and is mentioned as a variation.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for facilitating editing of text, comprising:
a processor;
a touch-sensitive display in communication with the processor, and
a memory storing a set of program modules executable by the processor, the set of modules includes,
an input module configured to detect a touch action on the touch sensitive display,
a processing module configured to:
determine if the touch action exceeds beyond a predefined threshold time, and determine an area of the touch action relative to a character
an output module configured to:
in response to the touch action and the threshold time, execute at least one function on an area of occurrence of the touch action, wherein the area of occurrence includes at least one character, at least a portion of a character, or an empty space.

2. The system of claim 1, wherein the output module is configured to: in response to the touch action and the threshold time, activate a virtual trackpad that allows movement of a pointer throughout the display relative to a touch input provided by movement of a users finger on the display.

3. The system of claim 1, wherein the function includes placement of a cursor, displaying a cursor, editing the character, automatic highlight of the character, magnifying the character, selecting the character and deleting the character.

4. The system of claim 1, wherein the area relative to the character includes a first area and a second area, wherein the first area defines an area occupied by the character and the second area defines an area around the character.

5. The system of claim 4, wherein, in response to touch action and threshold time at the first area, at least one function is executed on the area of occurrence of the touch action.

6. The system of claim 4, wherein, in response to touch action and threshold time at the second area, at least one function is executed on the area of occurrence of the touch action.

7. The system of claim 2, wherein the input module is configured to enable the user to drag one or more characters from one area of the display and drop at another area of the display for execution of at least one function utilizing the virtual trackpad.

8. The system of claim 3, wherein the automatic deletion of character involves:
placement of cursor at an area requiring deletion function, beyond a predefined threshold of time;
detect the placement of cursor at the area requiring deletion beyond the predefined threshold of time, and
deleting the selected area on removal of touch contact by a user from the display.

9. The system of claim 3, wherein the automatic highlight of character is implemented by placement of the cursor by a user at an area of the character requiring highlight for a predefined threshold time.

10. The system of claim 3, wherein the magnifying function is implemented by moving the cursor over the character for selection by a user, and magnifying the character on the display if the touch action exceeds beyond a predefined threshold time.

11. A method for facilitating text editing incorporated in a system comprising a processor, a touch-sensitive display, and a memory storing a set of program modules executable by the processor, comprising the steps of:
detecting, at the processor via an input module, a touch action on the touch sensitive display;
determining, at the processor via a processing module, if the touch action exceeds beyond a predefined threshold time, and determine an area of the touch action relative to a character;
in response to the touch action and the threshold time, executing, at the processor via the output module, at least one function on an area of occurrence of the touch action, wherein the area of occurrence includes at least one character, at least a portion of a character, or an empty space.

12. The method of claim 11, wherein the function includes placement of a cursor, displaying a cursor, editing the character, automatic highlight of the character, magnifying the character, selecting the character and deleting the character.

13. The method of claim 11, wherein the area relative to the character includes a first area and a second area, wherein the first area defines an area occupied by the character and the second area defines an area around the character.

14. The method of claim 13, wherein, in response to touch action and threshold time at the first area, at least one function is executed on the area of occurrence of the touch action.

15. The method of claim 13, wherein, in response to touch action and threshold time at the second area, at least one function is executed on the area of occurrence of the touch action.

16. The method of claim 11, wherein the input module is configured to enable the user to drag one or more characters from one area of the display and drop at another area of the display for execution of at least one function utilizing a virtual trackpad.

17. The method of claim 12, wherein the automatic deletion of character involves:
placing cursor at an area requiring deletion function, beyond a predefined threshold of time;
detecting the placement of cursor at the area requiring selection and deletion beyond the predefined threshold of time, and
deleting the selected character on removal of touch action by a user from the display.

18. The method of claim 12, wherein the automatic highlight of character is implemented by placement of the cursor at an area of the character requiring highlight for a predefined threshold time by a user.

19. A method for correcting typos on a touch sensitive screen comprising the steps of:
touching a character on the keyboard for a predefined threshold time to activate a virtual keyboard;
dragging a cursor to an output window to correct the character having typo
dropping the cursor at the position of the character having typo
wherein in response to dropping the cursor, at least one function is executed on the position of the character having typo.

20. The method of claim 19, wherein the function includes substituting the character, adding the character, and deleting the character.

21. A system for correcting typos on a touch sensitive screen comprising:
a processing module that analyses the last recorded position of a cursor before a user ends a touch action on the screen,
wherein the processing module places a cursor at last recorded position if last position was not occupied by a character and highlights the character if the last recorded position was over the character.
